(19) United States
(12) Patent Application Publication
(10) Pub. No.: US 2004/0222957 A1
(43) Pub. Date: Nov. 11, 2004

(54) [A LINE INVERSION DRIVE DEVICE FOR THIN FILM TRANSISTOR LIQUID CRYSTAL DISPLAY]

(76) Inventors: Chih-Yueh Lo, Hsinchu (TW); Hung-Min Shin, Changhua County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/708,229

(22) Filed: Feb. 18, 2004

(30) Foreign Application Priority Data
May 7, 2003 (TW) 92112401

(51) Int. Cl. G09G 3/36

(52) U.S. Cl. 345/92

(57) ABSTRACT

The present invention also provides a line inversion drive circuit for a thin film transistor liquid crystal display. The line inversion drive circuit comprises a clock controller and a data line driver. The clock controller includes a data inversion circuit for receiving a data signal and a clock control device; the data inversion circuit is coupled to the clock control device; the data inversion circuit responsive to an inversion control signal determines whether to invert the data signal and outputs a display signal. The data line driver, coupled to the data inversion device, is for receiving a group of reference voltages; the data line driver responsive the group of reference voltages and the display signal drives a plurality of data lines of the thin film transistor liquid crystal display. The present invention uses a single group of reference voltages only for both non-inverse and inverse data signals.

### CROSS REFERENCE TO RELATED APPLICATIONS

This application claims the priority benefit of Taiwan application Ser. No. 92112401, filed May 07, 2003.

### BACKGROUND OF INVENTION

1. Field of the Invention

This invention generally relates to a drive device for thin film transistor (“TFT”) liquid crystal display (“LCD”), and more particularly to a line inversion drive device for thin film transistor liquid crystal display.

2. Description of Related Art

Cathode ray tube (“CRT”) display products have dominated the display markets for a long time because of their good image quality and cheaper price. However, CRT display products consume more power and take more space than LCD display products.

LCD display has been used in electronic calculators and watches in 1970s. As the technology advances, it has been widely used in electronic products (such as portable TVs, videophones, laptop computers, desktop PC display and projective TVs) because of its superior image quality, low power consumption, low-voltage driven feature, and smaller size. The display markets are trending toward LCD display products rather than CRT LCD display products.

Most TFT-LCD displays adopt line inversion drive structure. FIG. 1 is a block diagram of a conventional line inversion drive device. Data drive device 110 includes a Gamma compensation circuit 102 and an inversion circuit 104. Gamma compensation circuit 102 sends its outputs to inversion circuit 104. LCD display's clock control circuit 106 is coupled to a switch circuit 108 and data drive device 110. Switch circuit 108 sends its outputs to Gamma compensation circuit 102. Data is fed into data drive device 110 for Gamma compensation first and then for inversion. Data drive device 110 coupled to a LCD display 112 and outputs signals to control LCD display 112.

The conventional line inversion drive device uses Gamma compensation circuit 102 to compensate the input data signals. This is because the input data signals are symmetrical signals, i.e., the voltage differences between each signal are the same, but the reference voltages (Vref1(+), Vref2(+), Vref3(+), Vref4(+), and Vref5(+)) are not symmetrical as shown in FIG. 2. FIG. 2 is an aperture rate-voltage curve for LCD displays. The aperture rate of LCD display depends on the voltage applied to the LCD display. To display the difference of color and brightness, the voltage differences between reference voltages are not the same, i.e., not symmetrical. Hence, Gamma compensation is required to compensate the input data signals to match the level of reference voltages.

Because the line inversion drive structure requires opposite polarity in every alternative line (e.g., lines 1, 3, 5 . . . are positive; lines 2, 4, 6 . . . are negative), two groups of reference voltages are required as shown in FIGS. 3a and 3b. This is because although the voltage differences ΔV₁, ΔV₂, ΔV₃, ΔV₄, ΔV₅, and ΔV₆ are the same, after line inversion, Vref1(+)≠Vref5(−) , Vref2(+)≠Vref4(−), Vref3(+)≠Vref3(−), Vref4(+)≠Vref2(−), and Vref5(+)≠Vref4(−). Hence, two groups of reference voltages are required for opposite polarities and the inversion circuit 104 is also required to inverse the polarity of the input data signals.

Then the LCD display's clock control circuit 106 controls the inversion circuit 104 to output the compensated input data signals with positive and negative polarities alternatively to data drive device 110. The clock control circuit 106 also controls the switch circuit to output those two groups of reference voltages to data drive device 110 alternatively corresponding to the input data signals with positive and negative polarities respectively. Data drive device 110 commands the LCD display 112 displays the color and brightness corresponding to the input data signals.

Hence, the conventional line inversion drive structure requires double reference voltage levels for LCD display compared to a non-inversion drive structure. For example, when LCD display requires 5 reference voltage levels, the conventional line inversion drive structure requires 10 reference voltage levels. This increases circuit complexity and device costs.

### SUMMARY OF INVENTION

An object of the present invention is to provide a line inversion drive device for TFT-LCD display to improve the drawbacks of the conventional line inversion drive structure.

The present invention provides a line inversion drive device for TFT-LCD display. The line inversion drive device, embedded in a clock controller, includes a data inversion circuit for receiving a data signal; the data inversion circuit determines whether to invert the data signal responsive to an inversion control signal and then output a display signal.

The present invention also provides a line inversion drive circuit for a thin film transistor liquid crystal display. The line inversion drive circuit comprises a clock controller and a data line driver. The clock controller includes a data inversion circuit for receiving a data signal and a clock control device; the data inversion circuit is coupled to the clock control device; the data inversion circuit responsive to an inversion control signal determines whether to invert the data signal and outputs a display signal. The data line driver, coupled to the data inversion device, is for receiving a group of reference voltages; the data line driver responsive the group of reference voltages and the display signal drives a plurality of data lines of the thin film transistor liquid crystal display. The data inversion circuit further comprises a Gamma compensation circuit coupled to the data inversion circuit to compensate the display signal.

The present invention also provides a line inversion drive method for a thin film transistor liquid crystal display to drive a plurality of data lines, comprising the steps of: receiving an input signal and a group of reference voltages; determining whether to invert the input signal responsive to an inversion control signal and output a display signal; compensating the display signal; and driving the plurality of data lines responsive to the compensated display signal and the group of reference voltages. The step of compensating the display signal is performed by Gamma compensation.

The above is a brief description of some deficiencies in the prior art and advantages of the present invention. Other features, advantages and embodiments of the invention will be apparent to those skilled in the art from the following description, accompanying drawings and appended claims.

### BRIEF DESCRIPTION OF DRAWINGS

FIG. 1 is a block diagram of a conventional line inversion drive device.

FIG. 2 is an aperture rate-voltage curve for LCD displays.

FIG. 3a shows the reference voltages with the positive polarity for a conventional line inversion drive structure.

FIG. 3b shows the reference voltages with the negative polarity for a conventional line inversion drive structure.

FIG. 4 is an aperture rate-voltage curve for transmission-type LCD displays.

FIG. 5 is a block diagram of a preferred embodiment of a line inversion drive device in accordance with the present invention.

FIG. 6 is a flow chart of a preferred embodiment of a line inversion drive method in accordance with the present invention.

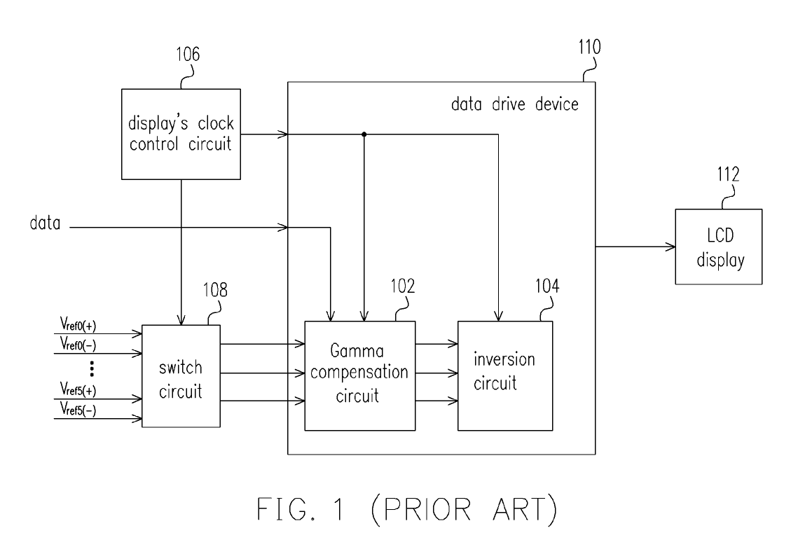

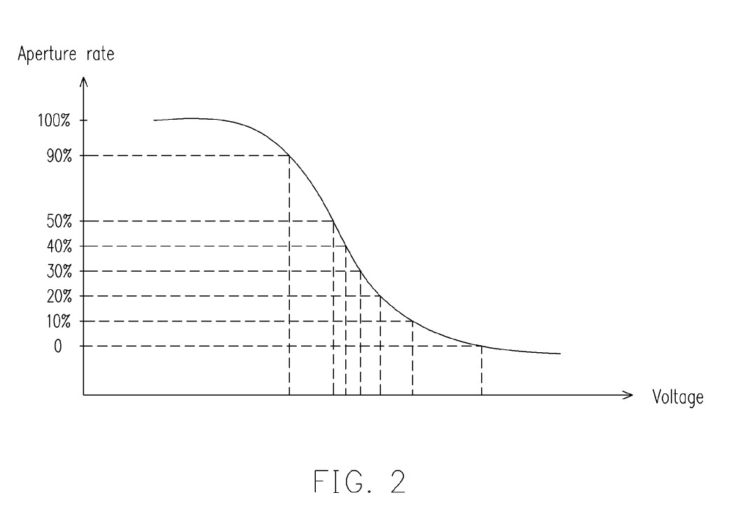

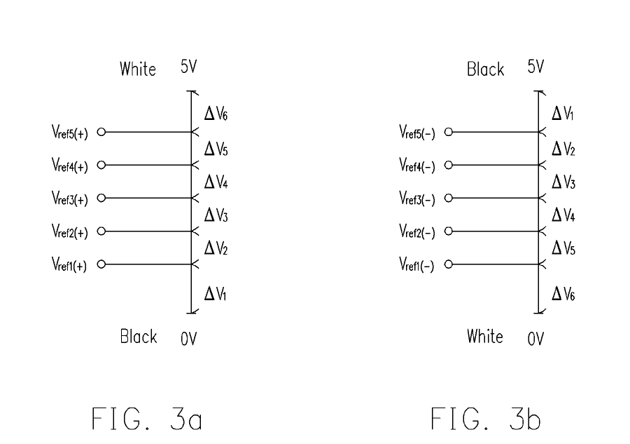

### DETAILED DESCRIPTION

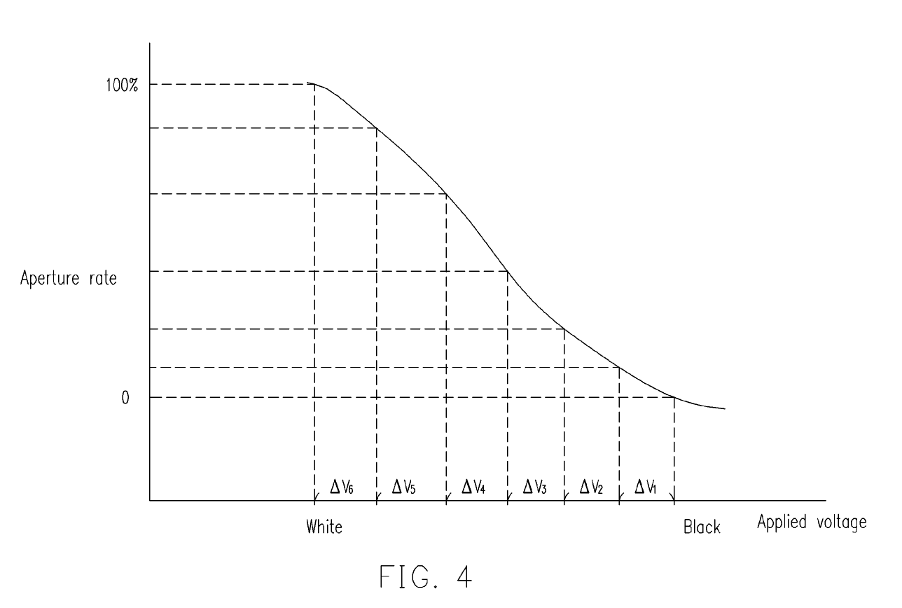

The line inversion drive device in accordance with the present invention can apply to transmission-type LCD display. FIG. 4 is an aperture rate-voltage curve for transmission-type LCD displays. The voltage differences between ΔV₁ and ΔV₂, ΔV₃ and ΔV₄, and ΔV₅ and ΔV₆ are almost the same. Hence, the present invention can invert the input data signal first and then performs Gamma compensation. The output displayed by the LCD display is substantially the same as the output of the conventional line inversion drive device. But the present invention reduces the numbers of reference voltage levels by half. Therefore, the entire circuit design is simpler and cheaper. But it should be noted that the resistors of the Gamma compensation circuit have to be set symmetrically, and the display have to be transmission-type LCD display.

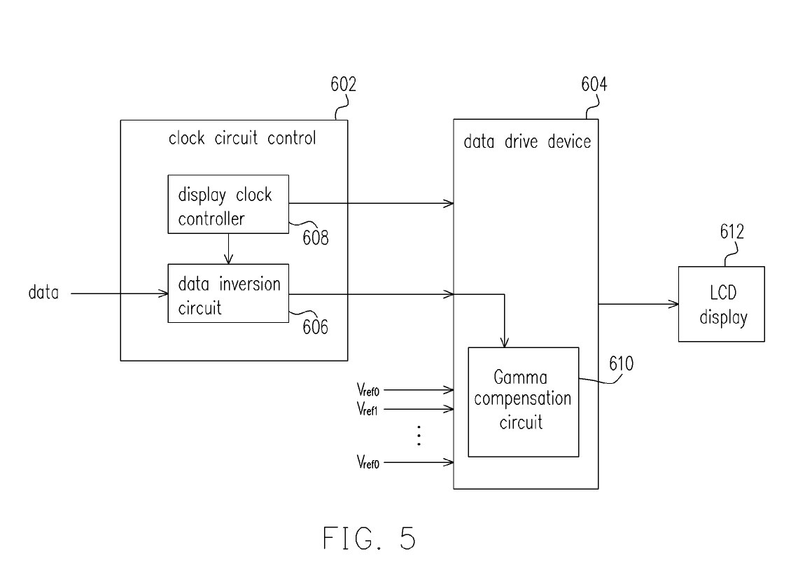

FIG. 5 is a block diagram of a preferred embodiment of a line inversion drive device in accordance with the present invention. Referring to FIG. 5, the line inversion drive device in accordance with the present invention, coupled to a LCD display, comprises a clock control circuit 602 and a data drive device 604. Clock control circuit 602 inverts the polarity of the input data signal and then outputs a display signal. The clock control circuit 602 outputs the input data signal and the inverse input data signal alternatively as the display signal. The data drive device 604 is coupled to the data inversion circuit 606 and the LCD display 612 for receiving the reference voltages. The data drive device 604 responsive to the display signal and the reference voltages drives the LCD display 612.

Furthermore, the clock control circuit 602 includes the data inversion circuit 606 and the LCD display clock controller 608. The data inversion circuit 606 inverts the polarity of the input data signal and outputs the input data signal and the inverse input data signal alternatively. The LCD display clock controller 608 is coupled to the data inversion circuit 606 to make the data inversion circuit 606 output the input data signal and the inverse input data signal alternatively.

Moreover, the data drive device 604 includes a Gamma compensation circuit 610. The Gamma compensation circuit 610 coupled to the data inversion circuit 606 compensates the display signal.

The line inversion drive device in accordance with the present invention works as follows. First, the data inversion circuit 606 receives the input data signal, and the data drive device receives the reference voltages. The data inversion circuit 606 inverts the polarity of the input data signal. Then The LCD display clock controller 608 controls the data inversion circuit 606 to output the input data signal and the inverse input data signal alternatively as the display signal to the Gamma compensation circuit 610. The Gamma compensation circuit 610 compensates the display signal. Then the data drive device 604 determines the reference voltage levels between which the display signal is located thereby making the LCD display 612 display the corresponding color and brightness.

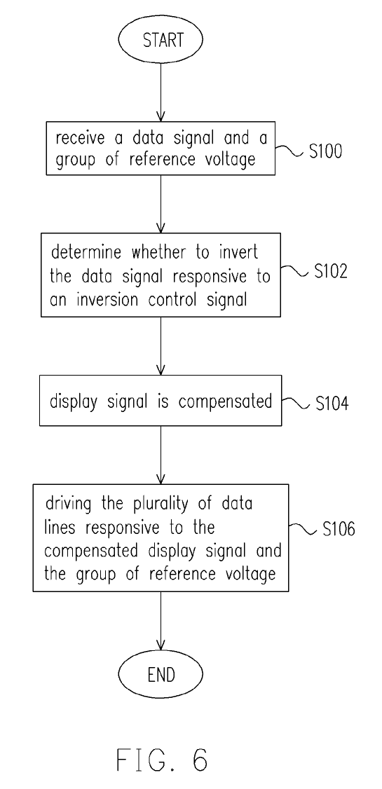

FIG. 6 is a flow chart of a preferred embodiment of a line inversion drive method in accordance with the present invention. The line inversion drive method for a thin film transistor liquid crystal display is to drive a plurality of data lines. First step (S100) is to receive a data signal and a group of reference voltages. Those reference voltages are always supplied to LCD display's data line driver. Later step (S102) is to determine whether to invert the data signal responsive to an inversion control signal. If the data signal is required to be inverted, the data signal is inverted and then outputted to the data line driver as a display signal; if the data signal is not required to be inverted, then the data signal is outputted to the data line driver directly as a display signal. Then the display signal is compensated (S104). For example, display signal is compensated by Gamma compensation. Final step (S106) is to driving the plurality of data lines responsive to the compensated display signal and the group of reference voltages.

Therefore, the present invention uses the same group of reference voltages for non-inverse and inverse data signals. Furthermore, because the data inversion circuit is embedded in the clock control circuit, the circuit design is much simpler and cost-effective.

Portable products also benefit from the present invention. For example, most existing PDAs are using the conventional line inversion drive structures and thus require an additional IC for switching 2 groups of reference voltages. The present invention does not require this additional IC because there is only single group of reference voltages.

The above description provides a full and complete description of the preferred embodiments of the present invention. Various modifications, alternate construction, and equivalent may be made by those skilled in the art without changing the scope or spirit of the invention. Accordingly, the above description and illustrations should not be construed as limiting the scope of the invention which is defined by the following claims.

1. A line inversion drive device for a thin film transistor liquid crystal display, embedded in a clock controller, comprising:
a data inversion circuit for receiving a data signal, said data inversion circuit responsive to an inversion control signal determining whether to invert said data signal and outputting a display signal.

2. A line inversion drive circuit for a thin film transistor liquid crystal display, comprising:
a clock controller including a data inversion circuit for receiving a data signal and a clock control device, said data inversion circuit being coupled to said clock control device, said data inversion circuit responsive to an inversion control signal determining whether to invert said data signal and outputting a display signal; and
a data line driver, coupled to said data inversion device, for receiving a group of reference voltages, said data line driver responsive said group of reference voltages and said display signal driving a plurality of data lines of said thin film transistor liquid crystal display.

3. The line inversion drive circuit for a thin film transistor liquid crystal display of claim 2, wherein said data inversion circuit further comprises a Gamma compensation circuit coupled to said data inversion circuit to compensate said display signal.

4. A line inversion drive circuit for a thin film transistor liquid crystal display, comprising:
a data inversion circuit for receiving a data signal;
a clock controller, coupled to said data inversion circuit, for generating an inversion control signal to said data inversion circuit to determine whether to invert said data signal, said data inversion circuit responsive to said inversion control signal outputting a display signal; and
a data line driver, coupled to said data inversion circuit, for receiving a group of reference voltages, said data line driver responsive said group of reference voltages and said display signal driving a plurality of data lines of said thin film transistor liquid crystal display.

5. A line inversion drive device for a thin film transistor liquid crystal display, comprising:
a data inversion circuit for receiving a data signal; and
a clock controller, coupled to said data inversion circuit, for generating an inversion control signal to said data inversion circuit to determine whether to invert said data signal, said data inversion circuit responsive to said inversion control signal outputting a display signal.

6. A line inversion drive method for a thin film transistor liquid crystal display to drive a plurality of data lines, comprising the steps of:
receiving an input signal and a group of reference voltages;
determining whether to invert said input signal responsive to an inversion control signal and output a display signal; compensating said display signal; and
driving said plurality of data lines responsive to said compensated display signal and said group of reference voltages.

7. The line inversion drive method for a thin film transistor liquid crystal display of claim 6, wherein said step of compensating said display signal is performed by Gamma compensation.
